(19) United States
(12) Patent Application Publication
(10) Pub. No.: US 2025/0372332 A1
(43) Pub. Date: Dec. 4, 2025

(54) MOLDED FILLER PAD FOR FUSE DEVICES

(71) Applicant: Littelfuse, Inc., Rosemont, IL (US)

(72) Inventors: Juliana Temple, Inverness, IL (US); Matthew Yurkanin, Mount Prospect, IL (US); Shabbir Dalal, Des Plaines, IL (US); Gary Bold, Palatine, IL (US)

(73) Assignee: Littelfuse, Inc., Rosemont, IL (US)

(21) Appl. No.: 19/218,691

(22) Filed: May 27, 2025

Related U.S. Application Data
(60) Provisional application No. 63/652,769, filed on May 29, 2024.

(51) Int. Cl. H01H 85/43; H01H 69/02; H01H 85/18; H01H 85/25

(52) U.S. Cl. CPC H01H 85/43; H01H 69/02; H01H 85/18; H01H 85/25

(57) ABSTRACT

A molded filler pad for encapsulating a fuse element can include one or more collection channels and one or more molded walls. The collection channels can guide conductive particulates from the fuse element along interior walls of a fuse body housing the fuse element to control any venting of the conductive particulates. The molded walls can press against the interior walls of the fuse body to control where the conductive particulars redeposit and prevent the same from redepositing in a connected path. The collection channels and the molded walls can be molded into a single device for filling the fuse body and be formed from a material that can remain undamaged and physically intact even when exposed to pressure and heat from an electrical arc of the fuse device that is produced as the fuse element opens to interrupt a circuit.

### CROSS-REFERENCE TO RELATED APPLICATIONS

The present application claims the benefit of priority to U.S. Provisional Patent Application No. 63/652,769, titled “MOLDED FILLER PAD FOR FUSE DEVICES” and filed May 29, 2024, the disclosure of which is incorporated herein by reference in its entirety.

### FIELD

The present disclosure generally relates to fuse devices. More particularly, the present disclosure relates to a molded filler pad for a fuse device.

### BACKGROUND

Fuse devices are well known in the art. However, known fuse devices are prone to venting when a fuse element opens. Known fuse devices are also prone to leakage currents conducting in redeposited materials that form a connected path when the fuse element opens. Indeed, when the fuse element opens, pressure and heat from an electrical arc often displace traditional fillers used in known fuse devices, such as quartz sand and silica sand, and when displaced, those fillers are deficient in preventing venting and leakage current.

In view of the above, there is a continuing, ongoing need for improved fuse devices.

### BRIEF SUMMARY

This Brief Summary is provided to introduce a selection of concepts in a simplified form that are further described below in the Detailed Description. This Brief Summary is not intended to identify key features or essential features of claimed subject matter or intended as an aid in determining scope of the claimed subject matter.

In some embodiments, a fuse device can include a fuse element disposed between a first electrical terminal and a second electrical terminal, a pad molded around and encapsulating the fuse element, and a housing encapsulating the pad, wherein the pad can include one or more features that can guide conductive particulates formed from the fuse element when opening.

In some embodiments, the pad can be over molded or insert molded around the fuse element.

In some embodiments, the one or more features can include one or more collection channels that can guide the conductive particulates along interior walls of the housing to control any venting of the conductive particulates.

In some embodiments, the one or more features can include a molded wall that can press against an interior wall of the housing to prevent the conductive particulates from redepositing in a connected path.

In some embodiments, the one or more features can include a first collection channel and a second collection channel that can guide the conductive particulates along interior walls of the housing to control any venting of the conductive particulates, and the molded wall can separate the first collection channel and the second collection channel.

In some embodiments, the pad can include a thermoplastic elastomer (TPE).

In some embodiments, the pad can include a thermoplastic vulcanizate (TPV) or a thermoplastic polyurethane (TPU).

In some embodiments, a pad for encapsulating a fuse element can include a first feature to control any venting of conductive particulates formed from the fuse element when opening and a second feature to control where the conductive particulars redeposit, wherein the first feature and the second feature can be molded into a single device for filling a fuse body housing the fuse element.

In some embodiments, the first feature and the second feature can be over molded or insert molded.

In some embodiments, the first feature can include one or more collection channels that can guide the conductive particulates along interior walls of the fuse body.

In some embodiments, the second feature can include a molded wall that can press against an interior wall of the fuse body to prevent the conductive particulates from redepositing in a connected path.

In some embodiments, the first feature can include a first collection channel and a second collection channel that can guide the conductive particulates along interior walls of the fuse body, and the molded wall can separate the first channel and the second channel.

In some embodiments, the single device can include a thermoplastic elastomer (TPE).

In some embodiments, the single device can include a thermoplastic vulcanizate (TPV) or a thermoplastic polyurethane (TPU).

In some embodiments, a method can include molding a pad around a fuse element to encapsulate the fuse element with the pad in a fuse device, controlling, with a first feature of the pad, any venting of conductive particulates formed from the fuse element when opening, and controlling, with a second feature of the pad, where the conductive particulates redeposit.

In some embodiments, the method can include over molding or insert molding the pad around the fuse element.

In some embodiments, the method can include the first feature guiding the conductive particulates along interior walls of a fuse body housing the fuse element, wherein the first feature can include one or more collection channels.

In some embodiments, the method can include the second feature preventing the conductive particulates from redepositing in a connected path, wherein the second feature can include a molded wall that can press against an interior wall of a fuse body housing the fuse element.

In some embodiments, the method can include the first feature guiding the conductive particulates along interior walls of the fuse body, wherein the first feature can include a first collection channel and a second collection channel, and wherein the molded wall can separate the first channel and the second channel.

In some embodiments, the pad can include a thermoplastic elastomer (TPE), a thermoplastic vulcanizate (TPV), or a thermoplastic polyurethane (TPU).

Other technical features may be readily apparent to one skilled in the art from the following figures, descriptions, and claims.

### BRIEF DESCRIPTION OF THE SEVERAL VIEWS OF THE DRAWINGS

FIG. 1 is a top cutaway view illustrating a fuse device with a molded filler pad in accordance with disclosed embodiments.

FIG. 2 is a perspective view of a fuse element disposed between electrical terminals in accordance with disclosed embodiments.

FIG. 3 is a perspective view of a molded filler pad encapsulating a fuse element in accordance with disclosed embodiments.

FIG. 4 is a cross-sectional view of a fuse device with a molded filler pad in accordance with disclosed embodiments.

FIG. 5 is a flow chart illustrating a method of constructing and operating a fuse device in accordance with disclosed embodiments.

### DETAILED DESCRIPTION

Exemplary embodiments of a molded filler pad for a fuse device in accordance with the present disclosure will now be described more fully hereinafter with reference made to the accompanying drawings. The molded filler pad may, however, be embodied in many different forms and should not be construed as being limited to the embodiments set forth herein. Rather, these embodiments are provided so that this disclosure will convey certain exemplary aspects of the molded filler pad to those skilled in the art.

In accordance with disclosed embodiments, a fuse device can include a fuse element disposed between a first electrical terminal and a second electrical terminal, a pad (i.e., the molded filler pad) molded around and encapsulating the fuse element, and a housing encapsulating the pad. The pad can include one or more features that can guide conductive particulates formed from the fuse element when opening, including, for example, metal particulates, copper, soot, vapor, and the like.

In some embodiments, the pad can include one or more collection channels that can guide the conductive particulates along interior walls of the housing to control any venting of the conductive particulates, including excessive materials forming the conductive particulates. Additionally or alternatively, in some embodiments, the pad can include a molded wall that can press against an interior wall of the housing to prevent the conductive particulates from redepositing in a connected path that might otherwise conduct leakage currents. In embodiments that include multiple ones of the collection channels and the molded wall, the molded wall can separate the collection channels, for example, by creating a seal to create separate chambers for the conductive particulates.

The pad can function as a filler material for the fuse device. In particular, the pad can fully encapsulate the fuse element in lieu of traditional filler materials, such as quartz sand and/or silica sand. Advantageously, the pad can remain undamaged and physically intact even when exposed to pressure and heat from an electrical arc of the fuse device that is produced as the fuse element opens to interrupt a circuit. Such an ability can allow the pad to continually guide the conductive particulates to controlled locations so that the pad, in combination with the housing, can capture those conductive particulates and prevent the same from venting with the pressure. Such an ability can also improve performance of the fuse device by (1) reducing arcing time, for example, by using the pressure to rapidly increase arc voltage and arrest the electrical arc, thereby reducing damage or potential damage to the housing and (2) continually guiding the conductive particulates to controlled locations so that the pad, in combination with the housing, can prevent those conductive particulates from redepositing to conduct leakage currents.

In accordance with the above, a manufacturing process to form the pad can include the pad being over molded and/or insert molded. The pad can include and/or be formed from any material that can remain undamaged and physically intact when exposed to the pressure and the heat from the electrical arc as disclosed herein. For example, in some embodiments, the pad can include a thermoplastic elastomer (TPE). In particular, in some embodiments, the pad can include a thermoplastic vulcanizate (TPV) and/or a thermoplastic polyurethane (TPU). Additionally or alternatively, the pad can include a thermoplastic resin or silicone. In any embodiment, a material of the pad can be moldable into specific shapes to form the features that guide the conductive particulates as disclosed herein.

The molded filler pad disclosed and described herein can be used in connection with any fuse device as would be known by one of ordinary skill in the art. For example, in some embodiments, the molded filler pad can be used in connection with high voltage fuses, including fuses rated up to 250V and/or 35 kA. Furthermore, in some embodiments, the molded filler pad can be used in connection with traditionally low voltage fuses that can perform well at high voltages because of the molded filler pad included therein. Still further, in some embodiments, the molded filler pad can be used in connection with bolt down automotive fuses. However, these specific types of fuses are exemplary only and do not limit the types of fuses with which the molded filler pad can used.

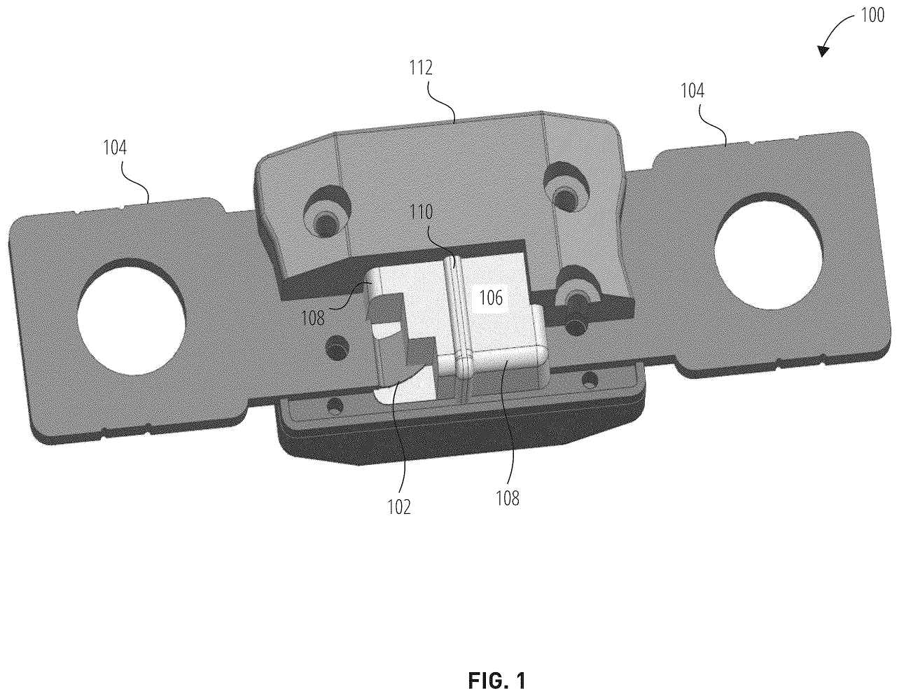

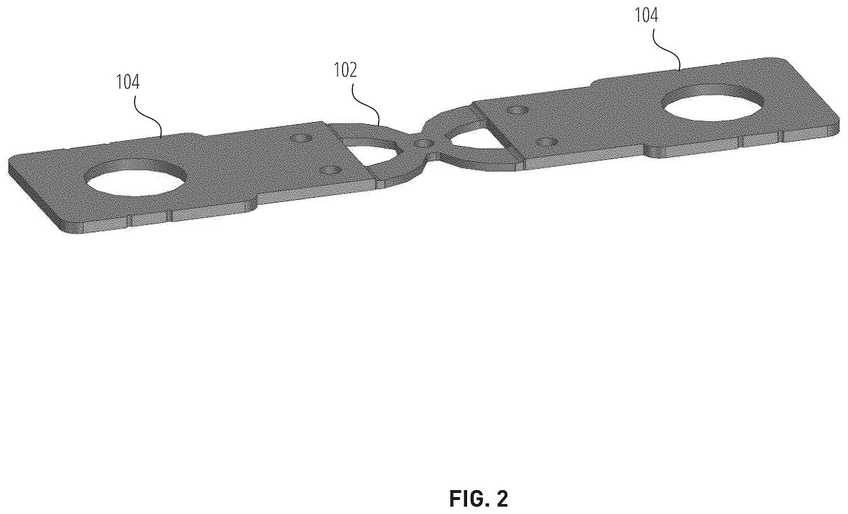

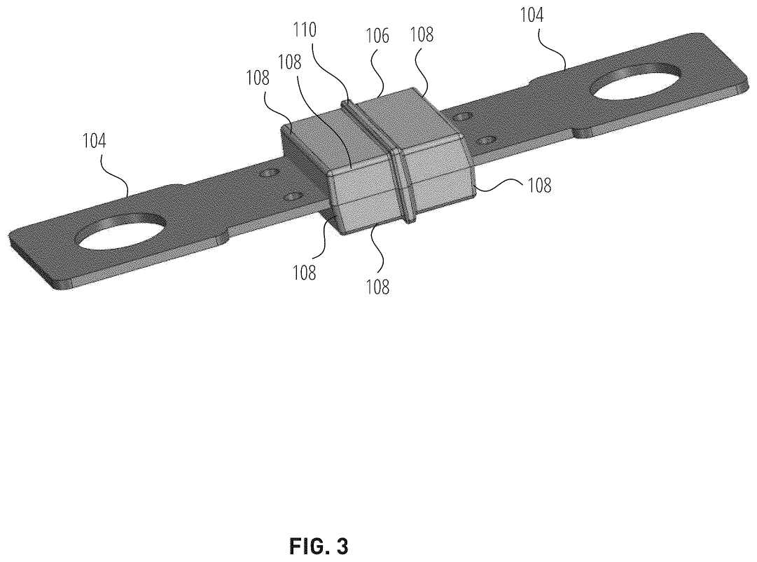

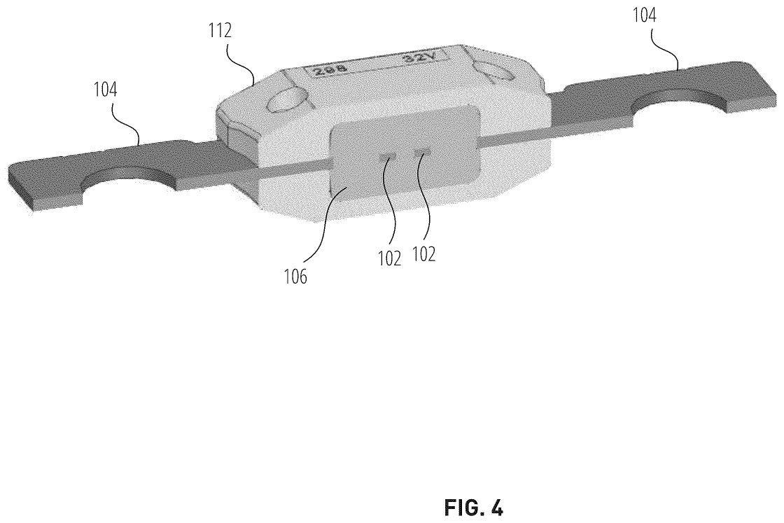

FIG. 1 is a top cutaway view illustrating a fuse device 100 with a pad 106 in accordance with disclosed embodiments, and FIG. 4 is a cross-sectional view of the fuse device 100 with the pad 106 in accordance with disclosed embodiments. FIG. 2 is a perspective view of a fuse element 102 disposed between electrical terminals 104 in accordance with disclosed embodiments, and FIG. 3 is a perspective view of the pad 106 encapsulating the fuse element 102 in accordance with disclosed embodiments

As best seen in FIG. 1 and FIG. 2, the fuse device 100 can include the fuse element 102 disposed between a first electrical terminal 104 and a second electrical terminal 104. As best seen in FIG. 1 and FIG. 3, the fuse device 100 can also include the pad 106 molded around and fully encapsulating the fuse element 102. As best seen in FIG. 1 and FIG. 4, the fuse device 100 can include the housing 112 encapsulating the pad 106.

As disclosed herein, the pad 106 can include features that can guide conductive particulates formed from the fuse element 102 when opening. For example, as best seen in FIG. 1 and FIG. 3, the pad 106 can include one or more collection channels 108 that can guide the conductive particulates along interior walls of the housing 112 to control any venting of the conductive particulates. Additionally or alternatively, the pad 106 can include a molded wall 110 that can press against an interior wall of the housing 112 to prevent the conductive particulates from redepositing in a connected path. In some embodiments, the molded wall 110 can separate some of the collection channels 108.

The collection channels 108 can create a gap, a space, and/or a chamber between the pad 106 and the housing 112 in which the conductive particulates can be collected. In some embodiments, the collection channels 108 can be located on tops, bottoms, sides, ends, corners, and/or edges of the pad 106. However, embodiments disclosed herein are not so limited. Indeed, materials forming the fuse element 102 vaporize along a path of the fuse element 102 and, therefore, are prone to predictable venting during an electrical arc of the fuse device 100. As such, the collection channels 108 can be molded into and located on the pad 106 in any locations that can predictably collect the conductive particulates between ends of the pad 106 and the housing 112 to control such venting.

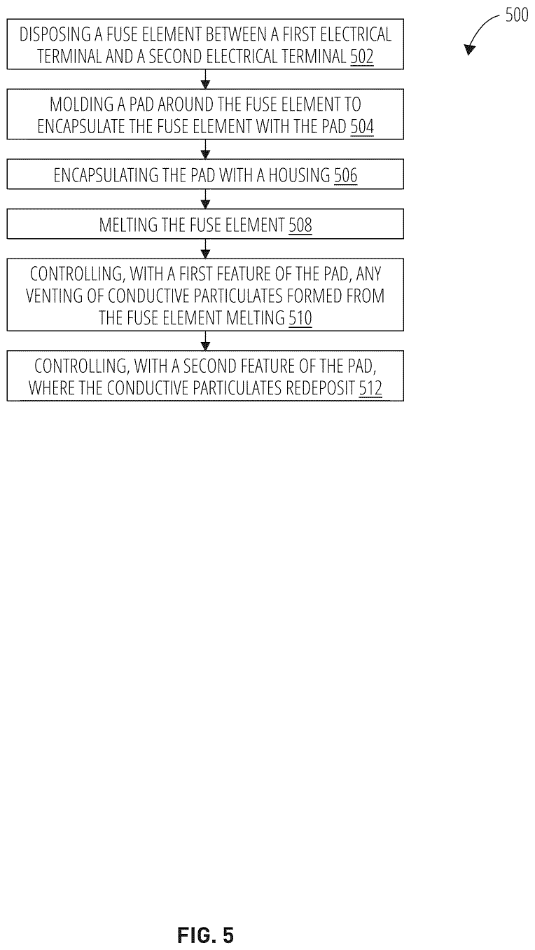

FIG. 5 is a flow chart illustrating a method 500 of constructing and operating a fuse device in accordance with disclosed embodiments. As seen in FIG. 5, to manufacture the fuse device, the method 500 can include disposing a fuse element between a first electrical terminal and a second electrical terminal as in 502 and molding a pad around the fuse element to encapsulate the fuse element with the pad as in 504. For example, the pad can be over molded or insert molded around the fuse element. Then, the method 500 can include encapsulating the pad with a housing as in 506.

In operation, the method 500 can include melting the fuse element as in 508 to open the fuse device and interrupt a circuit. Thereafter, the method 500 can include controlling, with a first feature of the pad, any venting of conductive particulates formed from the fuse element melting as in 510 and controlling, with a second feature of the pad, where the conductive particulates redeposit as in 512. For example, the first feature, such as one or more collection channels, can guide the conductive particulates along interior walls of a fuse body housing the element to control venting of the conductive particulates. The second feature, such as a molded wall that can press against an interior wall of the fuse body, can prevent the conductive materials from redepositing in a connected path.

As used herein, an element or a step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations, and changes to the described embodiments are possible without departing from the sphere and scope of the present disclosure, as defined in the appended claims. Accordingly, it is intended that the present disclosure not be limited to the described embodiments, but that it has the full scope defined by the language of the following claims and equivalents thereof.

What is claimed is:

1. A fuse device comprising:
a fuse element disposed between a first electrical terminal and a second electrical terminal;
a pad molded around and encapsulating the fuse element; and
a housing encapsulating the pad,
wherein the pad includes one or more features that guide conductive particulates formed from the fuse element when opening.

2. The fuse device of claim 1 wherein the pad is over molded or insert molded around the fuse element.

3. The fuse device of claim 1 wherein the one or more features include one or more collection channels that guide the conductive particulates along interior walls of the housing to control any venting of the conductive particulates.

4. The fuse device of claim 1 wherein the one or more features include a molded wall that presses against an interior wall of the housing to prevent the conductive particulates from redepositing in a connected path.

5. The fuse device of claim 4 wherein the one or more features include a first collection channel and a second collection channel that guide the conductive particulates along interior walls of the housing to control any venting of the conductive particulates, and wherein the molded wall separates the first collection channel and the second collection channel.

6. The fuse device of claim 1 wherein the pad includes a thermoplastic elastomer (TPE).

7. The fuse device of claim 6 wherein the pad includes a thermoplastic vulcanizate (TPV) or a thermoplastic polyurethane (TPU).

8. A pad for encapsulating a fuse element, the pad comprising:
a first feature to control any venting of conductive particulates formed from the fuse element when opening; and
a second feature to control where the conductive particulars redeposit,
wherein the first feature and the second feature are molded into a single device for filling a fuse body housing the fuse element.

9. The pad of claim 8 wherein the first feature and the second feature are over molded or insert molded.

10. The pad of claim 8 wherein the first feature includes one or more collection channels that guide the conductive particulates along interior walls of the fuse body.

11. The pad of claim 8 wherein the second feature includes a molded wall that presses against an interior wall of the fuse body to prevent the conductive particulates from redepositing in a connected path.

12. The pad of claim 11 wherein the first feature includes a first collection channel and a second collection channel that guide the conductive particulates along interior walls of the fuse body, and wherein the molded wall separates the first channel and the second channel.

13. The pad of claim 8 wherein the single device includes a thermoplastic elastomer (TPE).

14. The pad of claim 13 wherein the single device includes a thermoplastic vulcanizate (TPV) or a thermoplastic polyurethane (TPU).

15. A method comprising:
molding a pad around a fuse element to encapsulate the fuse element with the pad in a fuse device;
controlling, with a first feature of the pad, any venting of conductive particulates formed from the fuse element when opening; and
controlling, with a second feature of the pad, where the conductive particulates redeposit.

16. The method of claim 15 further comprising:
over molding or insert molding the pad around the fuse element.

17. The method of claim 15 further comprising:
the first feature guiding the conductive particulates along interior walls of a fuse body housing the fuse element,
wherein the first feature includes one or more collection channels.

18. The method of claim 15 further comprising:
the second feature preventing the conductive particulates from redepositing in a connected path,
wherein the second feature includes a molded wall that presses against an interior wall of a fuse body housing the fuse element.

19. The method of claim 18 further comprising:
the first feature guiding the conductive particulates along interior walls of the fuse body,
wherein the first feature includes a first collection channel and a second collection channel, and
wherein the molded wall separates the first channel and the second channel.

20. The method of claim 15 wherein the pad includes a thermoplastic elastomer (TPE), a thermoplastic vulcanizate (TPV), or a thermoplastic polyurethane (TPU).
